(19) United States
(12) Patent Application Publication
(10) Pub. No.: US 2026/0128221 A1
(43) Pub. Date: May 7, 2026

(54) MULTILAYER CERAMIC CAPACITOR

(71) Applicant: SAMSUNG ELECTRO-MECHANICS CO., LTD., Suwon-si (KR)

(72) Inventors: Jehee Lee, Suwon-si (KR); Jiseop Oh, Suwon-si (KR); Jihyun Lee, Suwon-si (KR); Hyungjoon Jeon, Suwon-si (KR); Jeong Ryeol Kim, Suwon-si (KR)

(73) Assignee: SAMSUNG ELECTRO-MECHANICS CO., LTD., Suwon-si (KR)

(21) Appl. No.: 19/232,509

(22) Filed: Jun. 9, 2025

(30) Foreign Application Priority Data
Nov. 5, 2024 (KR) 10-2024-0155174
Dec. 31, 2024 (KR) 10-2024-0202230

(51) Int. Cl. H01G 4/12; H01G 4/30

(52) U.S. Cl. CPC H01G 4/1227; H01G 4/30

(57) ABSTRACT

A multilayer ceramic capacitor includes a capacitor body having a dielectric layer and an internal electrode layer, and an external electrode disposed on an outer surface of the capacitor body. The dielectric layer contains a plurality of dielectric grains, at least one of which has a core-shell structure including a core portion and a shell portion that surrounds at least part of the core portion. The dielectric grain includes barium (Ba), titanium (Ti), and rare-earth elements including lanthanum (La). In a measurement region extending from the interface between the core and shell portions to a depth of about 5 nm into the shell portion, an absolute value of the concentration gradient of lanthanum (La) is approximately 0.12 to 0.58 parts by mole per nanometer, based on 100 parts by mole of titanium (Ti).

### CROSS-REFERENCE TO RELATED APPLICATION

This application claims priority to and the benefit of Korean Patent Application No. 10-2024-0202230 filed in the Korean Intellectual Property Office on Dec. 31, 2024, and Korean Patent Application No. 10-2024-0155174 filed in the Korean Intellectual Property Office on Nov. 5, 2024, the entire contents of which are incorporated herein by reference.

### BACKGROUND

### (a) Technical Field

The present disclosure relates to a multilayer ceramic capacitor.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, a technology has been proposed to reduce the thicknesses of the dielectric layer and internal electrode layer to achieve ultra-high capacitance in ultra-small multilayer ceramic capacitors. Additionally, design research is being conducted to achieve uniform resistance distribution by controlling the grain size and distribution within the dielectric layer.

### SUMMARY

An embodiment provides a multilayer ceramic capacitor having excellent DC bias characteristics.

An embodiment provides a multilayer ceramic capacitor including a capacitor body including a dielectric layer and an internal electrode layer, and an external electrode disposed on an outer surface of the capacitor body, wherein the dielectric layer includes a plurality of dielectric grains, at least one of the plurality of dielectric grains has a core-shell structure including a core portion and a shell portion surrounding at least a portion of the core portion, the dielectric grain having the core-shell structure includes barium (Ba), titanium (Ti), and rare-earth elements including lanthanum (La), and in a measurement region from an interface between the core portion and the shell portion to a depth of about 5 nm from the interface toward the shell portion, when measured from the interface toward the shell portion, an absolute value of a concentration gradient of lanthanum (La) is about 0.12 part by mole/nm to about 0.58 part by mole/nm based on 100 parts by mole of titanium (Ti).

In a TEM-EDS (transmission electron microscopy-energy dispersive spectroscopy) line analysis for a long-axis straight section passing through a center of the dielectric grain having the core-shell structure, the core portion may be a region in which lanthanum (La) is less than about 0.8 part by mole based on 100 parts by mole of titanium (Ti), and the shell portion may be a region in which lanthanum (La) is about 0.8 part by mole or more based on 100 parts by mole of titanium (Ti).

Lanthanum (La) may have a higher molar content in the shell portion than in the core portion.

In the shell portion, a content of lanthanum (La) may be about 0.8 part by mole or more and about 2.0 parts by mole or less based on 100 parts by mole of titanium (Ti).

The rare-earth elements may further include at least one auxiliary element selected from scandium (Sc), yttrium (Y), neodymium (Nd), europium (Eu), gadolinium (Gd), terbium (Tb), dysprosium (Dy), holmium (Ho), erbium (Er), ytterbium (Yb), and lutetium (Lu).

The rare-earth elements may further include auxiliary elements including yttrium (Y), terbium (Tb), and dysprosium (Dy).

The capacitor body may include an active region in which the dielectric layer and the internal electrode layer are alternately disposed, and in a central region having a horizontal length corresponding to about ⅙ of a total horizontal length of the active region each facing in a direction perpendicular to a stacking direction from an exact center of the active region, and a vertical length corresponding to about ⅙ of a total vertical length of the active region each facing in a stacking direction from an exact center of the active region, an average size of the dielectric grains having the core-shell structure may be about 10 nm or more and less than about 130 nm.

In the central region, an average size of the core portion may be about 35% to about 67.3% of the average size of the dielectric grains.

Another embodiment provides a multilayer ceramic capacitor including a capacitor body including a dielectric layer and an internal electrode layer, and an external electrode disposed on an outer surface of the capacitor body, wherein the dielectric layer includes a plurality of dielectric grains, at least one of the plurality of dielectric grains has a core-shell structure including a core portion and a shell portion surrounding at least a portion of the core portion, the dielectric grain having the core-shell structure includes barium (Ba), titanium (Ti), and rare-earth elements, and the rare-earth elements include lanthanum (La); and at least one auxiliary element selected from scandium (Sc), yttrium (Y), neodymium (Nd), europium (Eu), gadolinium (Gd), terbium (Tb), dysprosium (Dy), holmium (Ho), erbium (Er), ytterbium (Yb) and lutetium (Lu), and in a measurement region from an interface between the core portion and the shell portion to a depth of about 5 nm from the interface toward the shell portion, when measured from the interface toward the shell portion, an absolute value of a total concentration gradient of the rare-earth elements is about 0.12 part by mole/nm to about 0.58 part by mole/nm based on 100 parts by mole of titanium (Ti).

A total content of the rare-earth elements may have a higher molar content in the shell portion than in the core portion.

In the shell portion, a total content of the rare-earth elements may be about 1.2 parts by mole or more and about 5.5 parts by mole or less based on 100 parts by mole of titanium (Ti).

The rare-earth elements may include La, Y, Tb, and Dy.

A total content of La, Y, Tb, and Dy may have a higher molar content in the shell portion than in the core portion.

In the shell portion, a total content of La, Y, Tb, and Dy may be about 1.2 parts by mole or more and about 5.5 parts by mole or less based on 100 parts by mole of titanium (Ti).

The multilayer ceramic capacitor according to an embodiment can have excellent DC bias characteristics.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure by disassembling the capacitor body of FIG. 1.

FIG. 5 is a schematic view showing the dielectric layer according to an embodiment.

FIG. 6 is a schematic view showing the dielectric grain according to an embodiment.

FIG. 7 is an enlarged view of region Ain FIG. 2.

FIGS. 8A and 8B are TEM-EDS (transmission electron microscopy-energy dispersive spectroscopy) mapping analysis images for the dielectric layer according to Example 1.

FIGS. 9A and 9B are TEM-EDS (transmission electron microscope-energy dispersive spectroscopy) line analysis images of the dielectric layer according to Example 1, and FIG. 9C is a graph showing a content of lanthanum (La) in the TEM-EDS line analysis.

FIGS. 10A and 10B are TEM-EDS (transmission electron microscope-energy dispersive spectroscopy) line analysis images of the dielectric layer according to Example 1, and FIG. 10C is a graph showing a total content of the rare-earth elements in the TEM-EDS line analysis.

FIG. 11 is a graph showing an average size of dielectric grains according to Example 1 and Comparative Example 2.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

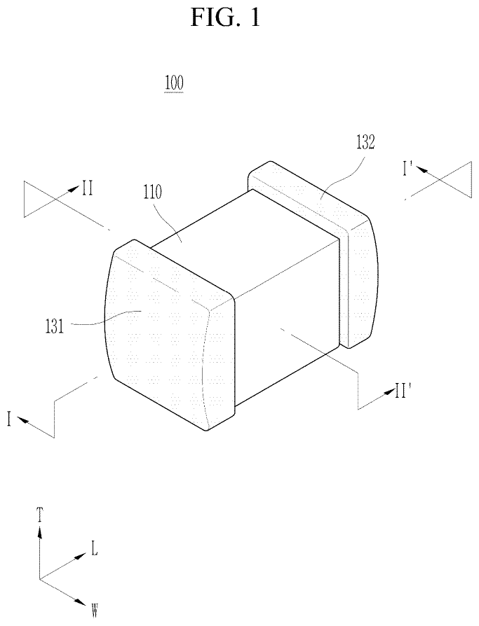

Hereinafter, a multilayer ceramic capacitor according to an embodiment will be described with reference to FIGS. 1 to 4.

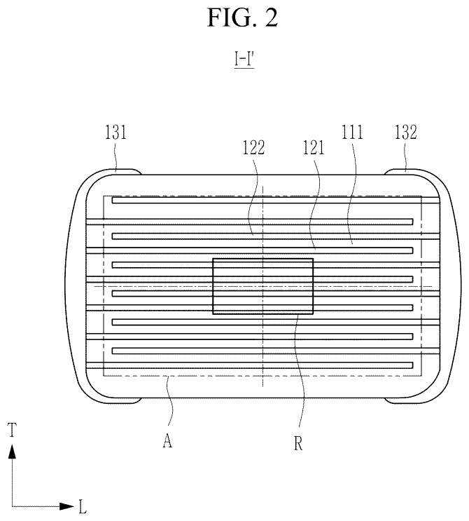

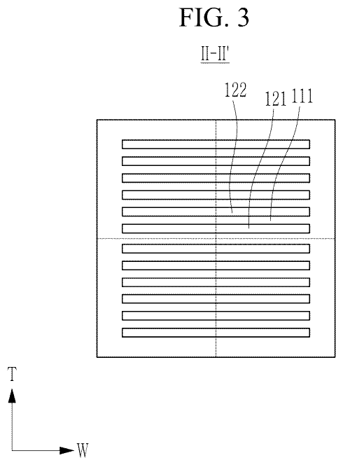

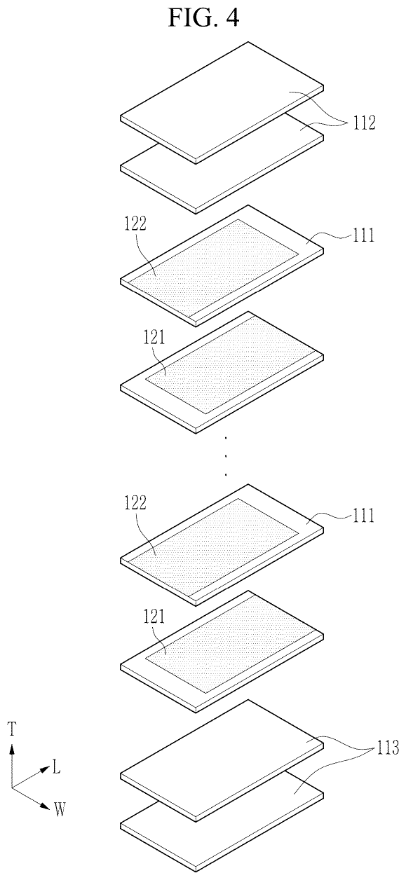

FIG. 1 is a perspective view showing a multilayer ceramic capacitor according to an embodiment, FIG. 2 is a cross-sectional view of the multilayer ceramic capacitor taken along line I-I′ of FIG. 1, FIG. 3 is a cross-sectional view of the multilayer ceramic capacitor taken along line II-II′ of FIG. 1, and FIG. 4 is an exploded perspective view illustrating the stacked structure by disassembling the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor according to an embodiment includes the capacitor body 110 and external electrodes 131 and 132 disposed on an outer surface of the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region A and cover regions 112 and 113.

The active region A is a region where the dielectric layer 111 and the internal electrode layers 121 and 122 are alternately stacked, which contributes to forming capacitance of the multilayer capacitor 100. Specifically, the active region A may be a region where the first internal electrode layer 121 and the second internal electrode layer 122 stacked along the thickness direction (T-axis direction) overlap.

The cover regions 112 and 113 are thickness-direction marginal portions, and may be positioned on the first and second surfaces of the active region A in the thickness direction (T-axis direction), respectively. The cover regions 112 and 113 may be a single dielectric layer 111 or two or more dielectric layers 111 stacked on the upper and lower surfaces of the active region A, respectively.

Additionally, the capacitor body 110 may further include side margin regions.

The side margin regions may be located on opposite side ends of the active region A in the width direction (W-axis direction), that is, on the fifth surface and the sixth surface, respectively. The side margin regions may be formed according as, when a conductive paste layer for the internal electrode is applies on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin regions serve to prevent damage to the first internal electrode layer 121 and the second internal electrode layer 122 due to physical or chemical stress.

### Dielectric Layer

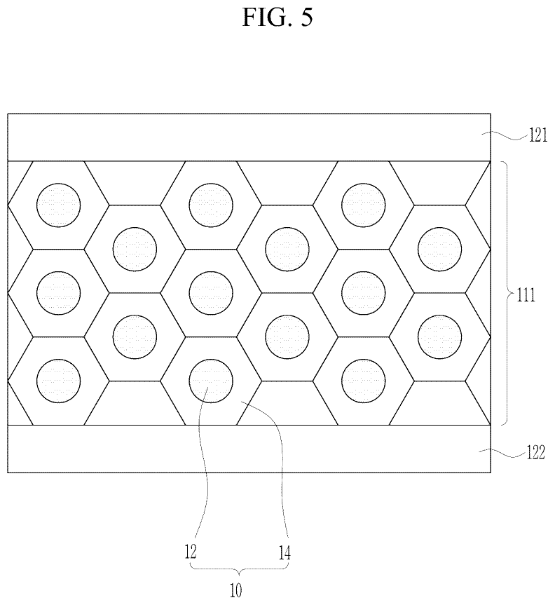

A dielectric layer 111 according to an embodiment will be described with reference to FIGS. 5 to 7.

FIG. 5 is a schematic view showing the dielectric layer according to an embodiment.

Referring to FIG. 5, a dielectric layer 111 according to an embodiment includes a plurality of dielectric grains 10, and at least one of the plurality of dielectric grains 10 has a core-shell structure including a core portion 12 and a shell portion 14 surrounding at least a portion of the core portion 12.

The dielectric grain 10 having the core-shell structure include barium (Ba), titanium (Ti), and rare-earth elements, and the rare-earth elements include lanthanum (La).

Specifically, barium (Ba) and titanium (Ti) can be derived from a barium titanate-based compound, which is a dielectric base material, and can be mainly included in the core portion 12 of the dielectric grain 10. The rare-earth elements including lanthanum (La) may be derived from additives added to the dielectric base material and may be mainly included in the shell portion 14 of the dielectric grain 10.

The barium titanate-based compound has a high dielectric constant, and contributes to forming the dielectric constant of a multilayer ceramic capacitor 100.

For example, the barium titanate-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca) (Ti, Sn)O₃, (Ba, Sr)TiO₃, (Ba, Sr) (Ti, Zr)O₃ and (Ba, Sr) (Ti, Sn)O₃.

The expression of dielectric properties of dielectric materials can be mainly explained by four polarization mechanisms. The polarization mechanisms include ionic polarization, which occurs when the equilibrium positions of electrons change when an electric field is applied to ionically bonded substances fixed in a lattice; electronic polarization, which occurs due to charge asymmetry caused by the movement of atomic nuclei; dipole polarization, which occurs from materials with self-polarization; and space charge polarization, which occurs when charge carriers within a material move under an applied electric field.

According to an embodiment, when the dielectric grain 10 having the core-shell structure within the dielectric layer 111 includes lanthanum (La), ionic polarization may occur, resulting in a giant permittivity. That is, when lanthanum (La) is substituted for barium (Ba) site of the dielectric base material and changes from a tetragonal to a cubic structure, the temperature at which resistance decreases, i.e. the curie temperature, is lowered, thereby enabling high dielectric constant at room temperature.

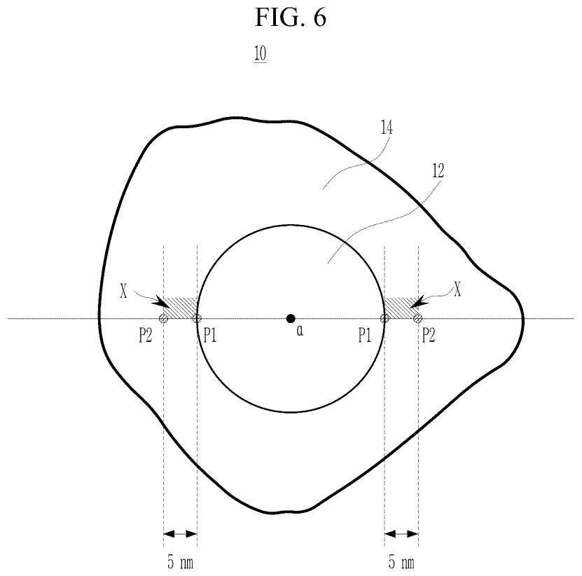

FIG. 6 is a schematic view showing the dielectric grain according to an embodiment.

Referring to FIG. 6, in the dielectric grain 10 having the core-shell structure, in a measurement region X from an interface between the core portion 12 and the shell portion 14 to a depth of about 5 nm from the interface toward the shell portion 14, when measured from the interface toward the shell portion 14, an absolute value of a concentration gradient of lanthanum (La) is about 0.12 part by mole/nm to about 0.58 part by mole/nm based on 100 parts by mole of titanium (Ti), for example, about 0.12 part by mole/nm to about 0.55 part by mole/nm, or about 0.12 part by mole/nm to about 0.50 part by mole/nm. When the absolute value of the concentration gradient of La in the above measurement region X is within the above range, not only does it have a high dielectric constant, but also the structural fraction of the core and shell portions is improved, thereby improving the DC bias characteristics of the multilayer ceramic capacitor. That is, when the absolute value of the concentration gradient of La is less than about 0.12 part by mole/nm and more than about 0.58 part by mole/nm based on 100 parts by mole of Ti, the DC bias characteristics of the multilayer ceramic capacitor may deteriorate.

In addition, the rare-earth elements according to an embodiment may further include one or more auxiliary elements selected from scandium (Sc), yttrium (Y), neodymium (Nd), europium (Eu), gadolinium (Gd), terbium (Tb), dysprosium (Dy), holmium (Ho), erbium (Er), ytterbium (Yb), and lutetium (Lu), in addition to lanthanum (La). For example, the rare-earth elements may include lanthanum (La), yttrium (Y), terbium (Tb), and dysprosium (Dy).

When the rare-earth elements include La and the auxiliary element, when measured from the interface between the core portion 12 and the shell portion 14 toward the shell portion 14 in the above measurement region X, an absolute value of a total concentration gradient of the rare-earth elements is about 0.12 part by mole/nm to about 0.58 part by mole/nm based on 100 parts by mole of titanium (Ti), for example, about 0.12 part by mole/nm to about 0.55 part by mole/nm, or about 0.12 part by mole/nm to about 0.50 part by mole/nm. Here, the total concentration of rare-earth elements means the sum of the contents of La and the auxiliary elements, and may be, for example, the sum of the contents of La, Y, Tb and Dy. When the absolute value of the total concentration gradient of the rare-earth elements in the above measurement region X is within the above range, not only does it have a high dielectric constant, but also the structural fraction of the core and shell portions is improved, thereby improving the DC bias characteristics of the multilayer ceramic capacitor. That is, when the absolute value of the total concentration gradient of the rare-earth elements is less than about 0.12 part by mole/nm and more than about 0.58 part by mole/nm based on 100 parts by mole of Ti, the DC bias characteristics of the multilayer ceramic capacitor may deteriorate.

In the measurement region X for the absolute value of the concentration gradient of La and the absolute value of the total concentration gradient of rare-earth elements, the interface between the core portion 12 and the shell portion 14 may be a point where La is about 0.8 part by mole based on 100 parts by mole of Ti when analyzing a TEM-EDS (transmission electron microscope-energy dispersive spectroscopy) line along the straight section of the long axis passing through a center a of the dielectric grain 10 having the core-shell structure. That is, the measurement region X for the absolute value of the concentration gradient of La can be a region from the point where La is about 0.8 part by mole based on 100 parts by mole of Ti to a depth of about 5 nm from the point toward the shell portion 14.

The absolute value of the concentration gradient of La and the absolute value of the total concentration gradient of the rare-earth elements, i.e., rare-earth elements including La and auxiliary elements, can be measured by a TEM-EDS (transmission electron microscopy-energy dispersive spectroscopy) line analysis.

Specifically, the multilayer ceramic capacitor 100 is placed in an epoxy mixing solution and cured, and then the L-axis and T-axis direction surface (LT surface) of the capacitor body 110 is polished to ½ depth in the W-axis direction to obtain a cross-sectional sample so that the active region A where the dielectric layer 111 and the internal electrode layers 121 and 122 intersect can be observed. For example, when the active region A is divided into three parts in the T-axis direction, i.e., the stacking direction, an upper region, a central region, and a lower region, a cross-sectional sample is obtained so that at least one dielectric layer and at least one internal electrode layer are visible in each region. Next, the obtained cross-sectional sample is measured using a transmission electron microscope (TEM). For example, TEM can be measured under conditions of acceleration voltage of 200 kV and magnification of 225 k using a focused ion beam (FIB). The TEM image of the measured cross-sectional sample was analyzed by EDS (energy dispersive spectroscopy) to confirm the dielectric grain 10 having the core-shell structure within the dielectric layer 111.

In addition, by performing EDS (energy dispersive spectroscopy) line analysis on the straight section of the long axis passing through the center a of the dielectric grain 10 having the core-shell structure in the TEM image, the absolute value of the concentration gradient of La and the absolute value of the total concentration gradient of rare-earth elements in the measurement region X can be measured, respectively. For example, by selecting two dielectric layers 111 in each region from the upper region, the central region, and the lower region within the active region A, and randomly selecting five dielectric grains 10 having the core-shell structure from each dielectric layer 111, the average value of the absolute value of the concentration gradient of La in the measurement region X and the average value of the absolute value of the total concentration gradient of rare-earth elements can be obtained for a total of 30 dielectric grains having the core-shell structure. At this time, the measurement region X can be a region from the interface between the core portion 12 and the shell portion 14 to a depth of 5 nm from the interface toward the shell portion 14, and measurement is performed from the interface toward the shell portion 14 in the measurement region X. In addition, the absolute value of the concentration gradient of La can be measured as the absolute value of the gradient of a straight line passing through two values: the La content value at a point P1 of the interface between the core portion 12 and the shell portion 14, and the La content value at a point P2 of a depth of 5 nm from the interface toward the shell portion 14. Similarly, the absolute value of the total concentration gradient of rare-earth elements can be measured as the absolute value of the gradient of a straight line passing through two values: the total content value of rare-earth elements at the point P1 and the total content value of rare-earth elements at the point P2. In addition, in the dielectric grain 10 having the core-shell structure, the dielectric grain 10 at which the point P2 at the depth of about 5 nm is located within the shell portion 14 is the measurement target.

For example, when analyzing a TEM-EDS (transmission electron microscope-energy dispersive spectroscopy) line along the straight section of the long axis passing through the center a of the dielectric grain 10 having the core-shell structure, the interface between the core portion 12 and the shell portion 14 may be a point where La is 0.8 part by mole based on 100 parts by mole of Ti. That is, the core portion 12 and the shell portion 14 can be distinguished based on the point where La is 0.8 part by mole based on 100 parts by mole of Ti. For example, the core portion 12 may be a region in which La is less than about 0.8 part by mole based on 100 parts by mole of Ti, and the shell portion 14 may be a region in which La is about 0.8 part by mole based on 100 parts by mole of Ti.

For example, in the TEM-EDS line analysis, La may have a higher molar content in the shell portion 14 than in the core portion 12. For example, the content of La in the shell portion 14 may be about 0.8 part by mole or more and about 2.0 parts by mole or less based on 100 parts by mole of Ti, for example, about 1.0 part by mole to about 2.0 parts by mole. When the content of La in the shell portion is within the above range, not only does it have a high dielectric constant, but also the structural fractions of the core portion and the shell portion are improved, thereby improving the DC bias characteristics of the multilayer ceramic capacitor.

In addition, when analyzing the TEM-EDS line, the total content of rare-earth elements may have a higher molar content in the shell portion 14 than in the core portion 12. For example, the total content of rare-earth elements in the shell portion 14 may be about 1.2 parts by mole or more and about 5.5 parts by mole or less based on 100 parts by mole of Ti, for example, about 1.3 parts by mole to about 5.0 parts by mole.

For example, the total content of La, Y, Tb, and Dy may have a higher molar content in the shell portion 14 than in the core portion 12. For example, the total content of La, Y, Tb, and Dy in the shell portion 14 may be about 1.2 parts by mole or more and about 5.5 parts by mole or less based on 100 parts by mole of Ti, for example, about 1.3 parts by mole to about 5.0 parts by mole.

When the total content of rare-earth elements in the shell portion, for example, the total content of La, Y, Tb and Dy, is within the above range, not only does it have a high dielectric constant, but also the structural fractions of the core portion and the shell portion are improved, thereby improving the DC bias characteristics of the multilayer ceramic capacitor.

The absolute value of the concentration gradient of La and the absolute value of the total concentration gradient of rare-earth elements can be obtained by controlling various process conditions, such as controlling the amount of rare-earth elements including La added when preparing the dielectric slurry or controlling the firing conditions such as the firing temperature.

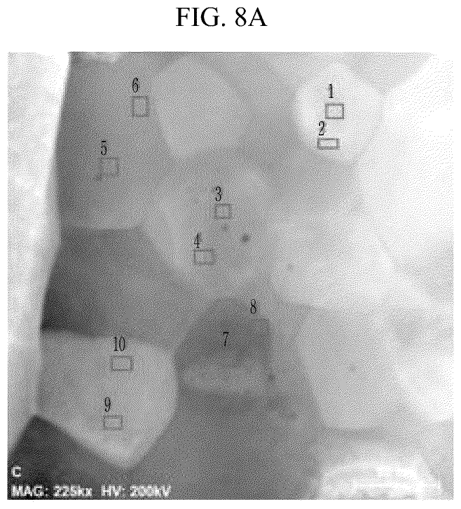

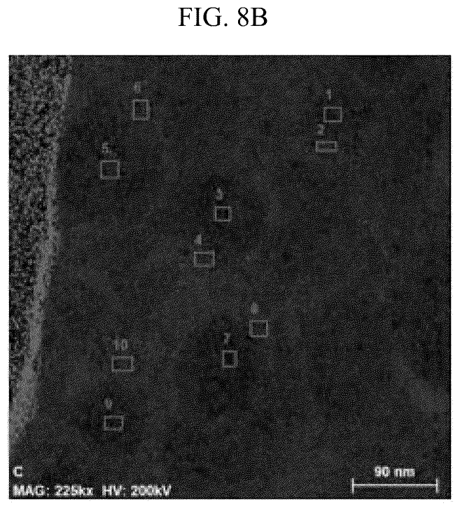

According to an embodiment, when the absolute value of the concentration gradient of La is within the above range, the dielectric grains 10 having the core-shell structure in the central region within the active region A can have a small average size. This can be specifically explained with reference to FIG. 8.

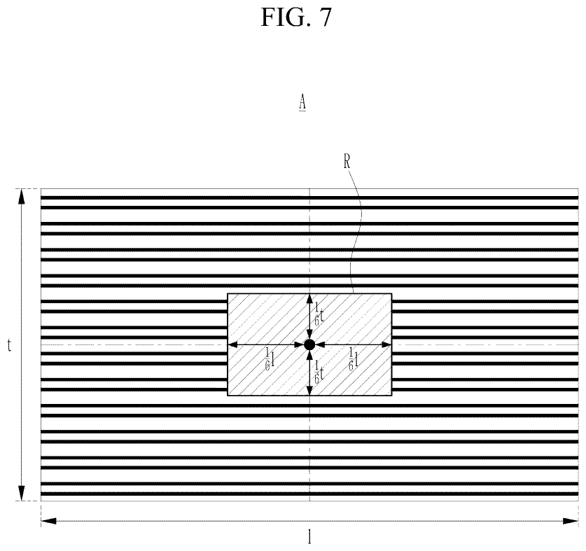

FIG. 7 is an enlarged view of region A in FIG. 2.

Referring to FIG. 7, the average size of the dielectric grains 10 having the core-shell structure in the central region R within the active region A may be about 10 nm or more and less than about 130 nm, for example, about 20 nm to about 129 nm, about 30 nm to about 128 nm, or about 40 nm to about 127 nm. At this time, the central region R may be a region having a horizontal length corresponding to about ⅙ of a total horizontal length l of the active region A each facing in a direction perpendicular to a stacking direction from an exact center Cp of the active region A, and a vertical length corresponding to about ⅙ of a total vertical length t of the active region A each facing in a stacking direction from an exact center Cp of the active region A. When the average size of the dielectric grains 10 having the core-shell structure is within the above range, not only does it have a high dielectric constant, but also the structural fraction of the core and shell portions is improved, thereby improving the DC bias characteristics of the multilayer ceramic capacitor.

Additionally, in the central region R, the average size of the core portion 12 may be about 35% to about 67.3% of the average size of the dielectric grains 10, for example, about 36% to about 67.3%, or about 37% to about 67.3% of the average size of the dielectric grains 10. When the average size of the core portion 12 is within the above range, not only does it have a high dielectric constant, but the structural fraction of the core portion and the shell portion can be improved, thereby improving the DC bias characteristics of the multilayer ceramic capacitor.

The average size of the dielectric grains 10 and the average size of the core portion 12 can be measured by the following methods.

The multilayer ceramic capacitor 100 is placed in an epoxy mixing solution and cured, and then the L-axis and T-axis direction surface (LT surface) of the capacitor body 110 is polished to ½ depth in the W-axis direction to obtain a cross-sectional sample so that the active region A where the dielectric layer 111 and the internal electrode layers 121 and 122 intersect can be observed. For example, when the active region A is divided into three parts in the T-axis direction, i.e., the stacking direction, an upper region, a central region, and a lower region, a cross-sectional sample is obtained so that at least one dielectric layer and at least one internal electrode layer are visible in the central region. Next, a central region R within the central region of the obtained cross-sectional sample, i.e., the central region R, which has a horizontal length corresponding to about ⅙ of a total horizontal length l of the active region A each facing in a direction perpendicular to a stacking direction from an exact center Cp of the active region A, and a vertical length corresponding to about ⅙ of a total vertical length t of the active region A each facing in a stacking direction from an exact center Cp of the active region A, is measured using a transmission electron microscope (TEM). For example, TEM can be measured under conditions of acceleration voltage of 200 kV and magnification of 225 k using a focused ion beam (FIB). By analyzing the TEM image of the measured cross-sectional sample with EDS (energy dispersive spectroscopy), the dielectric grains 10 having the core-shell structure existing in the central region R within the active region A can be confirmed, and then the average size of the dielectric grains 10 and the average size of the core portion 12 can be measured.

Here, the average size of the dielectric grains 10 can be calculated as an average value of the sizes of at least two, for example, five, dielectric grains 10 existing in the central region R, and the average size of the core portion 12 can be calculated as an average value of the sizes of the core portion 12 within the five identical dielectric grains 10, for example.

At this time, the size of the dielectric grain 10 can be obtained as the average value of the major axis length having the maximum diameter and the minor axis length having the minimum diameter passing through the center a of the dielectric grain 10, as shown in FIG. 6. In addition, the average size of the core portion 12 can be obtained as the average value of the size of the core portion 12 obtained on the major axis length having the maximum diameter and the size of the core portion 12 obtained on the minor axis length having the minimum diameter passing through the center a of the dielectric grain 10.

An average thickness (average length in the T-axis direction) of the dielectric layer 111 may be about 0.1 μm to about 8 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 can be measured by placing the multilayer ceramic capacitor 100 in an epoxy mixing solution, curing it, polishing it, and then ion milling it, and then analyzing it using a scanning electron microscope (SEM). SEM can be measured under conditions of, for example, 10 kV and a magnification of 100 times, and can be measured so that at least 1 layer, 3 layers, 5 layers, or 10 layers of dielectric layers 111 are visible in the active region where the dielectric layer 111 and the internal electrode layers 121 and 122 intersect. In the SEM image, the average thickness of the dielectric layer can be obtained by taking the central point of the length direction (L-axis direction) or width direction (W-axis direction) of the dielectric layer 111 as a reference point in the scanning electron microscope (SEM) image, and taking the mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted. In addition, by extending this average value measurement to 10 dielectric layers and measuring the average value, the average thickness of the dielectric layer can be more generalized.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by the dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 include a conductive metal, and may include at least one selected from among metals such as Ni, Cu, Ag, Pd, Au, and alloys thereof.

Additionally, the internal electrode layers 121 and 122 may include dielectric particles having the same composition as the ceramic material included in the dielectric layer 111.

The internal electrode layers 121 and 122 can be formed using a conductive paste including the conductive metal. The printing method for the conductive paste can be either screen printing or gravure printing.

Each average thickness of the first internal electrode layer 121 and the second internal electrode layer 122 may be about 0.1 μm to about 2 μm.

The average thickness of the first internal electrode layer 121 and the second internal electrode layer 122 may be measured by a scanning electron microscope (SEM) analysis. Specifically, in the SEM image of the cross-sectional sample obtained by the same method as the method for measuring the average thickness of the dielectric layer 111, the average thickness of the internal electrode layers can be obtained by taking the central point of the length direction (L-axis direction) or width direction (W-axis direction) of each of the internal electrode layers 121 and 122 as a reference point, and taking the mean value of the thickness of each of the internal electrode layers 121 and 122 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within each of the internal electrode layers 121 and 122, and if all 10 points are not positioned within each of the internal electrode layers 121 and 122, the position of the reference point may be changed, or the interval between the 10 points may be adjusted. In addition, by extending this average value measurement to 10 internal electrode layers and measuring the average value, the average thickness of the internal electrode layers can be more generalized.

The capacitor body 110 may be formed by firing a stacking structure in which the plurality of dielectric layers 111 and internal electrode layers 121 and 122 are stacked.

### External Electrode

The external electrodes 131 and 132, i.e., the first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces or the fifth and sixth surfaces of the capacitor body 110. The first and second band portions may serve to improve the adhesion strength of the first external electrode 131 and the second external electrode 132.

The external electrodes 131 and 132 may include a sintered metal layer in contact with the capacitor body 110, a conductive resin layer disposed to cover the sintered metal layer, and a plating layer disposed to cover the conductive resin layer.

The sintered metal layer may include a conductive metal and glass.

The conductive metal may include one or more selected from copper (Cu), nickel (Ni), silver (Ag), palladium (Pd), gold (Au), platinum (Pt), tin (Sn), tungsten (W), titanium (Ti), lead (Pb), and alloys thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the external electrodes 131 and 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

### Method of Manufacturing Multilayer Ceramic Capacitor

Hereinafter, a method of manufacturing the multilayer ceramic capacitor 100 according to an embodiment will be described.

A multilayer ceramic capacitor 100 according to an embodiment may be manufactured by preparing a dielectric slurry by mixing a barium titanate-based compound and rare-earth element-containing compounds including a lanthanum (La)-containing compound; manufacturing a dielectric green sheet using the dielectric slurry and forming a conductive paste layer on a surface of the dielectric green sheet; manufacturing a dielectric green sheet stack by stacking a plurality of the dielectric green sheets on which the conductive paste layer is formed; manufacturing a capacitor body including a dielectric layer and an internal electrode layer by firing the dielectric green sheet stack; and forming an external electrode on a surface of the capacitor body.

The rare-earth element-containing compounds may further include one or more auxiliary element-containing compound selected from a scandium (Sc)-containing compound, a yttrium (Y)-containing compound, a neodymium (Nd)-containing compound, a europium (Eu)-containing compound, a gadolinium (Gd)-containing compound, a terbium (Tb)-containing compound, a dysprosium (Dy)-containing compound, a holmium (Ho)-containing compound, an erbium (Er)-containing compound, a ytterbium (Yb)-containing compound, and a lutetium (Lu)-containing compound. For example, the rare-earth element-containing compounds may include a lanthanum (La)-containing compound, a yttrium (Y)-containing compound, a terbium (Tb)-containing compound, and a dysprosium (Dy)-containing compound.

The lanthanum (La)-containing compound can be mixed in an amount of about 0.1 part by mole to about 2 parts by mole based on 100 parts by mole of the barium titanate-based compound, for example, about 0.3 part by mole to about 1.8 parts by mole. When the lanthanum (La)-containing compound is mixed within the above content range, dielectric grains having improved structural fractions of the core and shell portions can be obtained, and a multilayer ceramic capacitor having high dielectric constant and excellent DC bias characteristics can be obtained.

In addition, when the auxiliary element-containing compound is mixed together, the total amount of the auxiliary element-containing compound can be mixed in an amount of about 1.2 parts by mole or more and 5.5 parts by mole or less based on 100 parts by mole of the barium titanate-based compound. When the total amount of the auxiliary element-containing compound is mixed within the above content range, dielectric grains having improved structural fractions of the core and shell portions can be obtained, and a multilayer ceramic capacitor having high dielectric constant and excellent DC bias characteristics can be obtained.

The lanthanum (La)-containing compound and the auxiliary element-containing compound may each be an oxide, a nitride, a salt compound, or a compound in the form of a sol dispersed in an organic solvent.

The dielectric slurry may be prepared by additionally mixing additives such as a dispersant, a binder, a plasticizer, a lubricant, an antistatic agent, and a solvent.

The dispersant may include for example at least one selected from a phosphoric acid ester-based dispersant and a polycarboxylic acid-based dispersant. The dispersant may be mixed in an amount of about 0.1 part by weight to about 5 parts by weight, for example, about 0.3 part by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduced.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes the internal electrode layer after firing, a conductive paste can be prepared by mixing a conductive powder made of a conductive metal or an alloy thereof, a binder, and a solvent. Additionally, barium titanate powder may be mixed in as a co-agent if necessary. The co-agent can act to inhibit the sintering of the conductive powder during the firing process. A conductive paste layer is formed by applying the conductive paste in a predetermined pattern on a surface of the dielectric green sheet using various printing methods such as screen printing or a transfer method.

The conductive powder may include nickel (Ni) or a nickel (Ni) alloy.

Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be manufactured after binder removal treatment (calcinating) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. Binder removal may be performed in an air or reducing atmosphere.

The firing may be performed at a temperature of more than about 1180° C. and less than about 1400° C. Additionally, the firing may be performed for about 0.5 hour to about 8 hours, for example, about 1 hour to about 3 hours. Additionally, the firing may be performed in a reducing atmosphere, for example, in a humidified mixed gas of nitrogen and hydrogen, and for example, may be performed under conditions such as a hydrogen concentration of 1.0% or less. When the internal electrode layer includes nickel (Ni) or a nickel (Ni) alloy, the oxygen partial pressure in the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepared capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on a surface of the manufactured capacitor body 110.

As an example, a paste for forming the sintered metal layer may be applied to the external electrode and then sintered to form the sintered metal layer.

The paste for forming the sintered metal layer may include a conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, a plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Examples 1 to 4

A dielectric slurry was prepared by mixing barium titanate (BaTiO₃), lanthanum nitrate (La(NO₃)₃), yttrium oxide (Y₂O₃), terbium oxide (Tb₄O₇), and dysprosium oxide (Dy₂O₃). At this time, La(NO₃)₃ was mixed in an amount of 0.5 part by mole based on 100 parts by mole of BaTiO₃, and a total amount of La(NO₃)₃, Y₂O₃, Tb₄O₇, and Dy₂O₃ was mixed in an amount of 1.8 part by mole based on 100 parts by mole of BaTiO₃.

The dielectric slurry was prepared by mechanical milling after adding ethanol/toluene, a wetting dispersant, and polyvinyl butyral (PVB) as a binder together using zirconia balls (ZrO₂ balls) as a dispersion medium.

The prepared dielectric slurry was used by using a head discharge type on-roll forming coater to manufacture a dielectric green sheet.

A conductive paste layer including nickel (Ni) was printed on a surface of the dielectric green sheet, and the dielectric green sheets on which the conductive paste layers were formed were stacked and pressed to manufacture a dielectric green sheet stack.

The dielectric green sheet stack was calcined at a temperature of 400° C. or less in a nitrogen atmosphere, and then fired under conditions of a specified temperature and a hydrogen concentration of 1.0% H₂ or less. Examples 1 to 4 were fired at temperatures of 1190° C., 1195° C., 1200° C., and 1205° C., respectively.

Next, a multilayer ceramic capacitor was manufactured through processes such as forming of external electrodes and plating.

### Comparative Example 1

A multilayer ceramic capacitor was manufactured in the same manner as in Example 1, except that La(NO₃)₃ was mixed in an amount of 0.01 part by mole based on 100 parts by mole of BaTiO₃.

### Comparative Example 2

A multilayer ceramic capacitor was manufactured in the same manner as in Example 2, except that La(NO₃)₃ was mixed in an amount of 0.01 part by mole based on 100 parts by mole of BaTiO₃.

### Comparative Example 3

A multilayer ceramic capacitor was manufactured in the same manner as in Example 1, except that it was fired at 1180° C.

### Comparative Example 4

A multilayer ceramic capacitor was manufactured in the same manner as in Example 1, except that it was fired at 1210° C.

### Comparative Example 5

A multilayer ceramic capacitor was manufactured in the same manner as in Example 1, except that it was fired at 1220° C.

### Evaluation 1: TEM-EDS Analysis

### (1) Identification of the Composition of Dielectric Grains

TEM-EDS (transmission electron microscopy-energy dispersive spectroscopy) mapping analysis was performed on the multilayer ceramic capacitors manufactured in Examples 1 to 4 and Comparative Examples 1 to 5 by the following method.

Each multilayer ceramic capacitor was placed in an epoxy mixing solution and cured, and then the L-axis and T-axis direction surface (LT surface) of the capacitor body was polished to ½ depth in the W-axis direction to obtain a cross-sectional sample so that the active region where the dielectric layer and the internal electrode layer intersect can be observed. At this time, when the active region was divided into three parts in the T-axis direction, i.e., the stacking direction, an upper region, a central region, and a lower region, a cross-sectional sample was obtained so that at least one dielectric layer and at least one internal electrode layer were visible in each region. Next, the obtained cross-sectional sample was measured using a transmission electron microscope (TEM) under the conditions of an acceleration voltage of 200 kV and a magnification of 225 k using a focused ion beam (FIB). Energy dispersive spectroscopy (EDS) mapping analysis was performed on the TEM images of the measured cross-sectional samples, and the results are shown in FIGS. 8A and 8B.

FIGS. 8A and 8B are TEM-EDS (transmission electron microscopy-energy dispersive spectroscopy) mapping analysis images for the dielectric layer according to Example 1.

Referring to FIGS. 8A and 8B, the EDS mapping analysis results confirmed that dielectric grains having the core-shell structure were present within the dielectric layer of Example 1, and it can be confirmed that the dielectric grains having the core-shell structure include Ba, Ti, and La.

### (2) Concentration Gradient of La and Total Concentration Gradient of Rare-Earth Elements

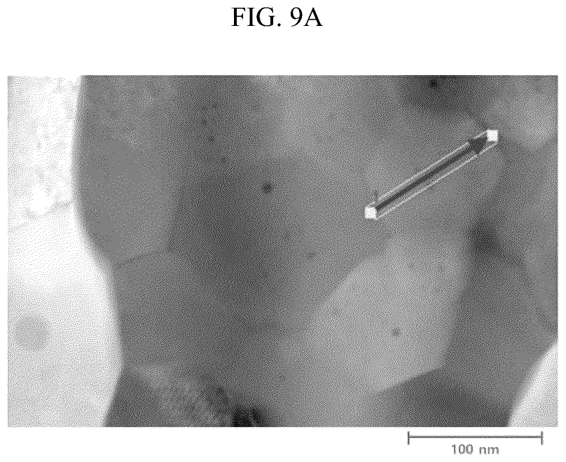

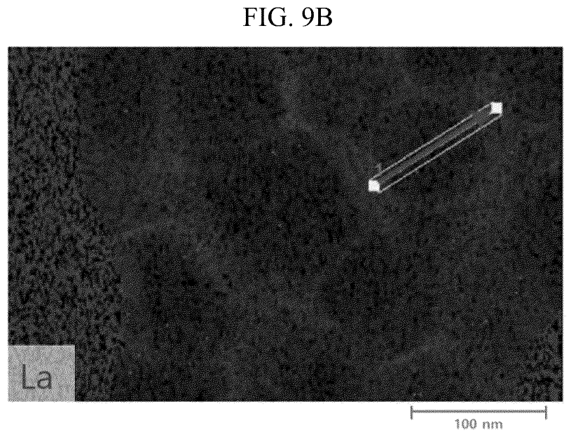

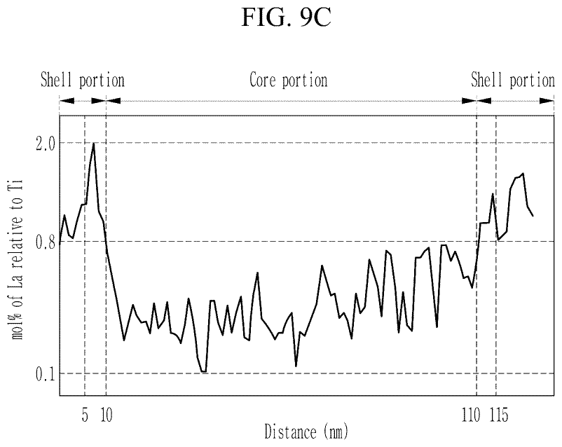

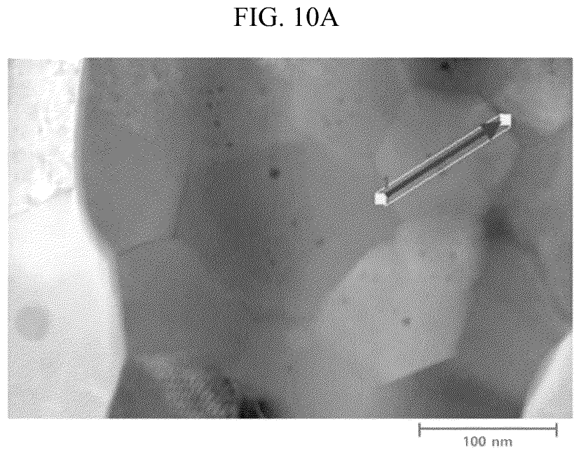

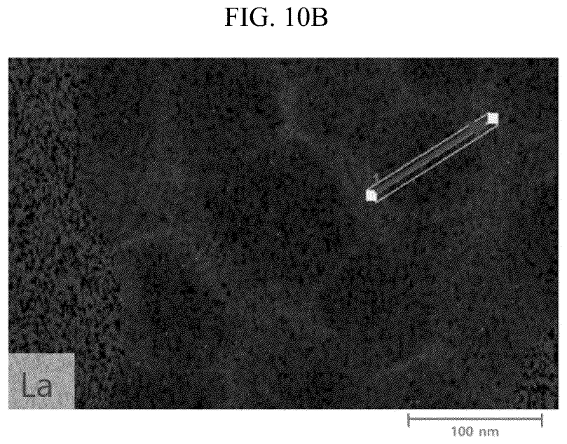

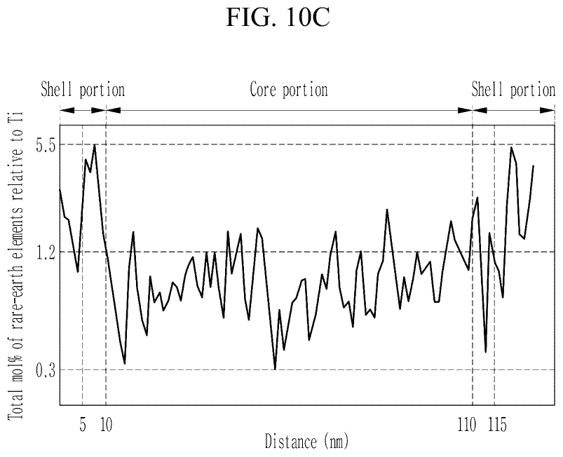

In the TEM image of the cross-sectional sample measured above, EDS (energy dispersive spectroscopy) line analysis was performed on the straight section of the long axis passing through the center of the dielectric grain having the core-shell structure, and the absolute value of the concentration gradient of La and the absolute value of the total concentration gradient of rare-earth elements in the measurement region X were measured, respectively, and the results are shown in FIG. 9A to FIG. 10C and Table 1 below.

At this time, by selecting two dielectric layers in each region from the upper region, the central region, and the lower region within the active region, and randomly selecting five dielectric grains 10 having the core-shell structure from each dielectric layer, the average value of the absolute value of the concentration gradient of La in the measurement region X and the average value of the absolute value of the total concentration gradient of rare-earth elements were obtained for a total of 30 dielectric grains having the core-shell structure. At this time, the measurement region X was designated as a region from the interface between the core portion and the shell portion to a depth of 5 nm from the interface toward the shell portion, and measurement was performed from the interface between the core portion and the shell portion toward the shell portion in the measurement region X. The absolute value of the concentration gradient of La was measured as the absolute value of the gradient of a straight line passing through two values: the La content value at a point P1 of the interface between the core portion and the shell portion, and the La content value at a point P2 of a depth of 5 nm from the interface toward the shell portion. Similarly, the absolute value of the total concentration gradient of rare-earth elements was measured as the absolute value of the gradient of a straight line passing through two values: the total content value of rare-earth elements at the point P1 and the total content value of rare-earth elements at the point P2. In addition, in the dielectric grain having the core-shell structure, the dielectric grain at which the point P2 at the depth of 5 nm is located within the shell portion is the measurement target.

FIGS. 9A and 9B are TEM-EDS (transmission electron microscope-energy dispersive spectroscopy) line analysis images of the dielectric layer according to Example 1, and FIG. 9C is a graph showing a content of lanthanum (La) in the TEM-EDS line analysis, and FIGS. 10A and 10B are TEM-EDS (transmission electron microscope-energy dispersive spectroscopy) line analysis images of the dielectric layer according to Example 1, and FIG. 10C is a graph showing a total content of the rare-earth elements in the TEM-EDS line analysis.

Referring to FIGS. 9A to 10C and Table 1 below, in the case of Examples 1 to 4, it can be seen that each absolute value of the concentration gradient of La, when measured from the interface between the core portion and the shell portion toward the shell portion in the measurement region X, was within the range of 0.12 part by mole/nm to 0.58 part by mole/nm based on 100 parts by mole of Ti.

Referring to FIGS. 10A to 10C and Table 1 below, in the case of Examples 1 to 4, it can be seen that each absolute value of a total concentration gradient of the rare-earth elements, when measured from the interface between the core portion and the shell portion toward the shell portion in the measurement region X, was within the range of 0.12 part by mole/nm to 0.58 part by mole/nm based on 100 parts by mole of Ti. At this time, the absolute value of the total concentration gradient of rare-earth elements represents the absolute value of the total concentration gradient of La, Y, Tb, and Dy.

At this time, it can be seen that the interface between the core portion and the shell portion is the point where La is approximately 0.8 part by mole based on 100 parts by mole of Ti.

In Table 1 below, the absolute value of the concentration gradient of La and the absolute value of the total concentration gradient of rare-earth elements are expressed based on 100 parts by mole of Ti.

TABLE 1

| | | Absolute value of total |
|---|---|---|
| | Absolute value of | concentration gradient of |
| | concentration gradient | rare-earth elements (parts |
| | of La (parts by mole/nm) | by mole/nm) |
| Example 1 | 0.12 | 0.12 |
| Example 2 | 0.14 | 0.14 |
| Example 3 | 0.39 | 0.39 |
| Example 4 | 0.58 | 0.58 |
| Comparative | 0.06 | 0.06 |
| Example 1 | | |
| Comparative | 0.08 | 0.08 |
| Example 2 | | |
| Comparative | 0.10 | 0.10 |
| Example 3 | | |
| Comparative | 0.60 | 0.60 |
| Example 4 | | |
| Comparative | 0.70 | 0.70 |
| Example 5 | | |

Through the above Table 1, it can be seen that in the cases of Examples 1 to 4, the absolute value of the concentration gradient of La is within the range of about 0.12 parts by mole/nm to about 0.58 parts by mole/nm based on 100 parts by mole of Ti, or the absolute value of the total concentration gradient of rare-earth elements including La, Y, Tb, and Dy is within the range of about 0.12 parts by mole/nm to about 0.58 parts by mole/nm based on 100 parts by mole of Ti.

### (3) Average Size of Dielectric Grains

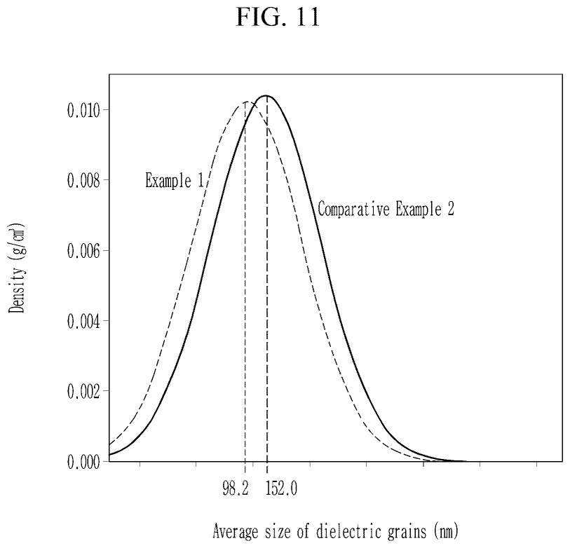

A central region R within the central region of the above obtained cross-sectional sample, i.e., the central region R, which has a horizontal length corresponding to ⅙ of a total horizontal length l of the active region each facing in a direction perpendicular to a stacking direction from an exact center Cp of the active region, and a vertical length corresponding to ⅙ of a total vertical length t of the active region each facing in a stacking direction from an exact center Cp of the active region, was measured using a transmission electron microscope (TEM) under the conditions of an acceleration voltage of 200 kV and a magnification of 225 k using a focused ion beam (FIB). By analyzing the measured TEM image with EDS (energy dispersive spectroscopy), the dielectric grains having the core-shell structure existing in the central region R within the active region were confirmed, and then the average size of the dielectric grains and the average size of the core portion were measured, respectively, and the results are shown in FIG. 11 and Table 2 below.

The average size of the dielectric grains was calculated as an average value of the sizes of five dielectric grains existing in the central region R, and the average size of the core portion was calculated as an average value of the sizes of the core portion within the five identical dielectric grains. At this time, the size of the dielectric grain was obtained as the average value of the major axis length having the maximum diameter and the minor axis length having the minimum diameter passing through the center a of the dielectric grain, and also the size of the core portion was obtained as the average value of the size of the core portion obtained on the major axis length having the maximum diameter and the size of the core portion obtained on the minor axis length having the minimum diameter passing through the center a of the dielectric grain.

FIG. 11 is a graph showing an average size of dielectric grains according to Example 1 and Comparative Example 2.

In Table 2 below, the size of the core portion is expressed as a ratio to the average size of the dielectric grains.

TABLE 2

| | | Absolute value | | |
|---|---|---|---|---|
| | | of total | | |
| | Absolute value | concentration | | |
| | of concentration | gradient of | Average | Size |
| | gradient of La | rare-earth | size of | of core |
| | (parts by mole/ | elements (parts | dielectric | portion |
| | nm) | by mole/nm) | grain (nm) | (%) |
| Example 1 | 0.12 | 0.12 | 98.2 | 50.03 |
| Example 2 | 0.14 | 0.14 | 101.0 | 53.00 |
| Example 3 | 0.39 | 0.39 | 127.9 | 58.85 |
| Example 4 | 0.58 | 0.58 | 129.0 | 67.29 |
| Comparative | 0.06 | 0.06 | 151.0 | 34.72 |
| Example 1 | | | | |
| Comparative | 0.08 | 0.08 | 152.0 | 38.28 |
| Example 2 | | | | |
| Comparative | 0.10 | 0.10 | 143.4 | 67.87 |
| Example 3 | | | | |
| Comparative | 0.60 | 0.60 | 144.0 | 68.00 |
| Example 4 | | | | |
| Comparative | 0.70 | 0.70 | 145.0 | 69.00 |
| Example 5 | | | | |

Through FIG. 11 and Table 2, it can be seen that in the cases of Examples 1 to 4, where the absolute value of the concentration gradient of La or the absolute value of the total concentration gradient of rare-earth elements is in the range of about 0.12 part by mole/nm to about 0.58 part by mole/nm based on 100 parts by mole of Ti, the average size of the dielectric grains becomes smaller compared to the cases of Comparative Examples 1 to 5, which are outside the above range.

### Evaluation 2: DC Bias Characteristic

The DC bias characteristics of the multilayer ceramic capacitors manufactured in Examples 1 to 4 and Comparative Examples 1 to 5 were evaluated by the following method, and the results are shown in Table 3 below.

After measuring the nominal capacitance under the conditions of 1 kHz and 0.5 Vrms, the effective capacitance was measured by applying 1 V DC and 3 V DC respectively under the conditions of 100 KHz and 0.01 Vrms, and the rate of change (ΔCp) of the effective capacitance compared to the nominal capacitance was calculated.

In Table 3 below, it was determined that the DC bias characteristics were deteriorated when ΔCp at 1 V DC was-22% or more or ΔCp at 3 V DC was-65% or more

TABLE 3

ΔCp (%)

| | @ 1 V DC | @ 3 V DC |
|---|---|---|
| Example 1 | −17.23 | −51.98 |
| Example 2 | −18.00 | −51.50 |
| Example 3 | −18.00 | −50.70 |
| Example 4 | −16.29 | −58.05 |
| Comparative | −28.00 | −55.40 |
| Example 1 | | |
| Comparative | −24.20 | −54.30 |
| Example 2 | | |
| Comparative | −23.14 | −53.18 |
| Example 3 | | |
| Comparative | −17.30 | −65.00 |
| Example 4 | | |
| Comparative | −15.67 | −76.42 |
| Example 5 | | |

Through the above Table 3, it can be confirmed that in the cases of Examples 1 to 4, where the absolute value of the concentration gradient of La or the absolute value of the total concentration gradient of rare-earth elements is in the range of about 0.12 part by mole/nm to about 0.58 part by mole/nm based on 100 parts by mole of Ti, the DC bias characteristics are superior compared to the cases of Comparative Examples 1 to 5, which are outside the above range.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outer surface of the capacitor body,
wherein the dielectric layer comprises a plurality of dielectric grains,
at least one of the plurality of dielectric grains has a core-shell structure including a core portion and a shell portion surrounding at least a portion of the core portion,
wherein the dielectric grain having the core-shell structure comprises barium (Ba), titanium (Ti), and rare-earth elements including lanthanum (La), and
in a measurement region from an interface between the core portion and the shell portion to a depth of 5 nm from the interface toward the shell portion, an absolute value of a concentration gradient of lanthanum (La) is 0.12 part by mole/nm to 0.58 part by mole/nm based on 100 parts by mole of titanium (Ti).

2. The multilayer ceramic capacitor of claim 1, wherein
in a TEM-EDS (transmission electron microscopy-energy dispersive spectroscopy) line analysis for a long-axis straight section passing through a center of the dielectric grain having the core-shell structure,
the core portion is a region in which lanthanum (La) is less than 0.8 part by mole based on 100 parts by mole of titanium (Ti), and
the shell portion is a region in which lanthanum (La) is 0.8 part by mole or more based on 100 parts by mole of titanium (Ti).

3. The multilayer ceramic capacitor of claim 1, wherein
lanthanum (La) has a higher molar content in the shell portion than in the core portion.

4. The multilayer ceramic capacitor of claim 1, wherein
in the shell portion, a content of lanthanum (La) is 0.8 part by mole or more and 2.0 parts by mole or less based on 100 parts by mole of titanium (Ti).

5. The multilayer ceramic capacitor of claim 1, wherein
the rare-earth elements further comprise at least one auxiliary element selected from a group consisting of scandium (Sc), yttrium (Y), neodymium (Nd), europium (Eu), gadolinium (Gd), terbium (Tb), dysprosium (Dy), holmium (Ho), erbium (Er), ytterbium (Yb), and lutetium (Lu).

6. The multilayer ceramic capacitor of claim 1, wherein
the rare-earth elements further comprise auxiliary elements including yttrium (Y), terbium (Tb), and dysprosium (Dy).

7. The multilayer ceramic capacitor of claim 1, wherein
the capacitor body comprises an active region in which the dielectric layer and the internal electrode layer are alternately disposed, and
in a central region having a horizontal length corresponding to ⅙ of a total horizontal length of the active region each facing in a direction perpendicular to a stacking direction from an exact center of the active region, and a vertical length corresponding to ⅙ of a total vertical length of the active region each facing in the stacking direction from the exact center of the active region, an average size of the dielectric grains having the core-shell structure is 10 nm or more and less than 130 nm.

8. The multilayer ceramic capacitor of claim 7, wherein
in the central region, an average size of the core portion is 35% to 67.3% of the average size of the dielectric grains.

9. A multilayer ceramic capacitor, comprising
a capacitor body including a dielectric layer and an internal electrode layer, and
an external electrode disposed on an outer surface of the capacitor body,
wherein the dielectric layer comprises a plurality of dielectric grains,
at least one of the plurality of dielectric grains has a core-shell structure including a core portion and a shell portion surrounding at least a portion of the core portion,
wherein the dielectric grain having the core-shell structure comprises barium (Ba), titanium (Ti), and rare-earth elements, and the rare-earth elements comprise lanthanum (La); and at least one auxiliary element selected from a group consisting of scandium (Sc), yttrium (Y), neodymium (Nd), europium (Eu), gadolinium (Gd), terbium (Tb), dysprosium (Dy), holmium (Ho), erbium (Er), ytterbium (Yb) and lutetium (Lu), and
in a measurement region from an interface between the core portion and the shell portion to a depth of 5 nm from the interface toward the shell portion, an absolute value of a total concentration gradient of the rare-earth elements is 0.12 part by mole/nm to 0.58 part by mole/nm based on 100 parts by mole of titanium (Ti).

10. The multilayer ceramic capacitor of claim 9, wherein
in a TEM-EDS (transmission electron microscopy-energy dispersive spectroscopy) line analysis for a long-axis straight section passing through a center of the dielectric grain having the core-shell structure,
the core portion is a region in which lanthanum (La) is less than 0.8 part by mole based on 100 parts by mole of titanium (Ti), and
the shell portion is a region in which lanthanum (La) is 0.8 part by mole or more based on 100 parts by mole of titanium (Ti).

11. The multilayer ceramic capacitor of claim 9, wherein
a total content of the rare-earth elements has a higher molar content in the shell portion than in the core portion.

12. The multilayer ceramic capacitor of claim 9, wherein
in the shell portion, a total content of the rare-earth elements is 1.2 parts by mole or more and 5.5 parts by mole or less based on 100 parts by mole of titanium (Ti).

13. The multilayer ceramic capacitor of claim 9, wherein
the capacitor body comprises an active region in which the dielectric layer and the internal electrode layer are alternately disposed, and
in a central region having a horizontal length corresponding to ⅙ of a total horizontal length of the active region each facing in a direction perpendicular to a stacking direction from an exact center of the active region, and a vertical length corresponding to ⅙ of a total vertical length of the active region each facing in the stacking direction from the exact center of the active region, an average size of the dielectric grains having the core-shell structure is 10 nm or more and less than 130 nm.

14. The multilayer ceramic capacitor of claim 13, wherein
in the central region, an average size of the core portion is 35% to 67.3% of the average size of the dielectric grains.

15. The multilayer ceramic capacitor of claim 9, wherein
the rare-earth elements comprise La, Y, Tb, and Dy.

16. The multilayer ceramic capacitor of claim 15, wherein
a total content of La, Y, Tb, and Dy has a higher molar content in the shell portion than in the core portion.

17. The multilayer ceramic capacitor of claim 15, wherein
in the shell portion, a total content of La, Y, Tb, and Dy is 1.2 parts by mole or more and 5.5 parts by mole or less based on 100 parts by mole of titanium (Ti).
